(19) United States
(12) Patent Application Publication
(10) Pub. No.: US 2004/0054676 A1
(43) Pub. Date: Mar. 18, 2004

(54) Systems and methods for automatically processing text information

(76) Inventors: Jay M. McNally, Providence, RI (US); Dean M. Felicetti, Providence, RI (US)

Correspondence Address: ROBERT J. DEPKE LEWIS T. STEADMAN, HOLLAND & KNIGHT LLC, 131 SOUTH DEARBORN, 30TH FLOOR, CHICAGO, IL, 60603, US

(21) Appl. No.: 10/245,657

(22) Filed: Sep. 16, 2002

(51) Int. Cl. G06F 7/00

(52) U.S. Cl. 707/100

(57) ABSTRACT

Systems and methods for automatically processing electronic data files found in a variety of different file formats are utilized in order to generate comprehensive output comprising all of the data contained within the files including hidden data. Additionally these systems and methods may be used to automatically generate a database of information pertaining to the files that have been processed by the system along with an identification of the specific processing that has been performed on the files. The database of this information is useful not only in determining the overall progress that has been made in the processing of the files but also to provide the ability to rapidly determine chain of custody and processing information. This database is useful in overcoming any challenges to use of the data that are generated by the systems and methods of the present invention.

### BACKGROUND OF THE INVENTION

1. Field of the Invention

The present invention relates generally to the field of automated electronic data processing systems. More specifically, the present invention is directed to improved systems and methods for automatically processing substantial volumes of electronic information in order to generate comprehensive output based on the original information contained in files including hidden data. The processing and/or manipulation of the underlying information is monitored and a database containing information concerning the processing and/or manipulation of the files is automatically updated and maintained.

2. Description of the Related Art

Information processing systems and electronic communication systems have now realized significant acceptance in both the professional business world and by individuals. Business entities throughout the world are generating vast quantities of electronic information in a variety of formats every day. Additionally, many individuals are also using these types of systems in their personal lives. Typical information processing systems that are used to generate this information include word processing programs such as, for example, Microsoft Word, and WordPerfect from Corel. Other conventional information processing systems that are currently used for generating electronic information include database management systems and spreadsheet programs such as, for example, Microsoft Excel and the like. There also are a great variety of communication systems that are widely available for generating electronic mail messages including Microsoft Outlook and Exchange as well as Linux Sendmail, for example.

It has now also been recognized that the information generated by these systems can be highly pertinent to issues in commercial litigation, government reviews and/or due diligence efforts. As a result, extremely large volumes of electronic document information and electronic mail must be processed and reviewed for the purpose of determining whether the underlying information is responsive and/or relevant to document requests in litigation or if it is otherwise relevant to an understanding of issues arising out of these matters.

In the past, the review of this information was based on an actual physical review of documents that were printed out from the native applications which had originally created the underlying information. More recently, systems have been developed to automatically process the underlying information and “print” the information into a common file format such as, for example, tiff images. A new database of information in a single common format was thus created for the purpose of providing convenient access to the information in a common format.

It is now also widely known that information contained within these files includes not only the readily apparent textual information but also other hidden data such as, for example, metadata that may be contained within the files. For example, a number of computer programs that are used to generate text such as word processing programs and like provide the ability to maintain previous draft information in a time-stamped format that maybe hidden and not readily available for viewing but nonetheless will be contained within the underlying file structure. It has been recognized that to the extent that this information is available, it should be analyzed during the review of the file in a manner that allows for the verification of the accuracy of the evidence. By revealing data, including, possibly, the state of mind of the author or reader, this information can prove to be some of the most valuable and enlightening information contained in all the data. Accordingly, it is preferable to process the files in order to ensure that this data may be readily observable during the subsequent review process.

One of the shortcomings of the existing file processing systems is that the resulting processed output data is subject to challenge due to failure to provide an adequate chain of custody for the information. A response to such a challenge requires that the proponent of the documentary evidence provide reasonable assurances as to the integrity of the data. Due to the substantial volume of data, this task can be extremely time-consuming and difficult. Currently, there are no systems available that are capable of providing quick and convenient access to this information. Furthermore, there are no existing systems that are capable of automatically generating chain of custody information and/or related processing information for electronic files that have been processed in this manner.

Accordingly, there remains a need for new and improved systems and methods that are capable of automatically generating chain of custody and/or processing information relating to the processing status of electronic data files for production. There also remains a need for new and improved systems and methods that are capable of simultaneously processing electronic data files on a plurality of computers which are programmed to generate comprehensive output in either a common format such as, for example, tiff files or through output generated from native applications. Other objects and advantages of the present invention will become apparent in light of the following Summary and detailed description of the presently preferred embodiments.

### SUMMARY OF THE INVENTION

The present invention is directed to systems and methods for automatically processing electronic data files found in a variety of different file formats in order to generate comprehensive output comprising all of the data contained within the files including hidden data. Additionally, in accordance with the preferred exemplary embodiment of the present invention, systems and methods are provided which automatically generate a database of information pertaining to the files that have been processed by the system along with an identification of the specific processing that has been performed on the files. The database of this information is useful not only in determining the overall progress that has been made in the processing of the files but it also provides the ability to rapidly determine chain of custody and processing information in order to validate the output data and confirm that the data is what it is it purports to be. This database is useful in overcoming any challenges to use of the data that are generated by the systems and methods of the present invention.

In accordance with a first preferred exemplary embodiment of the present invention, systems and methods are disclosed which are capable of simultaneously processing electronic data files on a plurality of computers that are programmed to generate comprehensive output in either a common format such as, for example, tiff files or through output generated from native applications. In accordance with the first preferred exemplary embodiment of the present invention, a file structure that may be comprised of a plurality of user data files including, for example, document files which may be found in a variety of different file formats and/or electronic mail files for a plurality of users, are processed to generate a comprehensive output comprising all of the information contained within the files including hidden information.

In accordance with the first preferred exemplary embodiment of the present invention, the overall directory structures containing all of the files to be processed is initially provided for processing by the processing computers. The underlying data or directory structures may be contained within a variety of different data storage devices that are physically delivered to the processing machines such as, for example, via CD-ROMs and/or hard disk drives and the like. Alternatively, the data may be provided to the processing system through a network connection such as, for example, the Internet or alternatively, through a local network connection.

In the preferred exemplary embodiment of the present invention, a plurality of processing machines which are preferably individual personal computers are connected to the data storage device containing the directory structure or structures that contain the files to be processed by the systems and methods of present invention.

In the preferred exemplary embodiment of the present invention, one of the personal computers connected to the processing network to which the storage device containing the data to be processed is also connected is utilized for generating a database of information pertaining to the files that are being processed by the systems and methods of the present invention. The database that is generated by this machine is automatically modified to include the processing that has been performed upon each of the individual files contained within the directory structure or structures.

A plurality of computers are preferably utilized to process the individual files contained within the directory structure in parallel in order to more efficiently process the underlying information. This is accomplished by assigning portions of the overall directory structure that is to be processed to each of the processing machines. In the preferred exemplary embodiment, this is accomplished by evaluating the quantity of underlying data and thereafter providing approximately an equivalent load on each of the processing machines. Those skilled in the art will appreciate that in an alternate embodiment, fewer machines may be utilized including even a single machine for the purpose of processing the data as described herein.

As various steps in the processing of the underlying data is performed, each of the individual machines updates the database containing the file processing information to thus provide a comprehensive list of the processing that has been performed on each of individual files. In the preferred exemplary embodiment, the database is an SQL database, however, those skilled in the art will appreciate that a variety of database formats may be utilized. In the preferred exemplary embodiment, for example, an e-mail message containing a .ZIP file is unzipped in order to determine the underlying file structure. If necessary, this step is performed again until a recognized file format is accessed. At each step along the way, the database is updated to include information pertaining to operations that have been performed on the file. In order to maintain verifiability of chain of custody, once a recognized file format has been identified, the file is then opened in its native format and then in one embodiment the file is printed to a common format such as, for example, the tiff image format. Alternatively, a new file is generated in the original file's native format for subsequent access.

The processing of the files includes steps of detecting the original file format of the underlying data and then opening and extracting all of the information from the file in order to ensure that the data is readily viewable by person who has access to the output file. Detecting and extracting is performed repeatedly as necessary on a file when, for example, the file is compressed.

In accordance with the preferred exemplary embodiment, when the file is opened in its native format, the file is manipulated to display any hidden text that may be available. For example, this may include such things as, for example, track changes information in Microsoft Word and other similar data. This processing information is similarly updated in the database to ensure that all of the relevant file processing information may be readily accessed.

The processing that may be performed includes the reconstruction of redlining information and the ability to render PowerPoint speaker notes into readily viewable text. The system is also preferably configured to automatically handle files that have been generated with an A4 paper size. Each instance of processing preferably occurs automatically and is recorded in the database. Those skilled in the art will recognize that these are merely examples of the processing that may be performed on the underlying data.

Other processing may be performed on the underlying data depending upon client requirements and the desired output. Advantageously, information pertaining to whatever processing has been performed by the processing machines on each of the files is updated and associated with the file upon which the processing has been performed. Comprehensive information concerning the files is thus available after processing of the files is completed.

### BRIEF DESCRIPTION OF THE DRAWINGS

FIG. 1 illustrates a first exemplary embodiment of present invention;

FIG. 2 illustrates an exemplary embodiment of present invention;

FIG. 3 illustrates an exemplary embodiment of present invention.

### DETAILED DESCRIPTION OF THE PRESENTLY PREFERRED EMBODIMENT'S

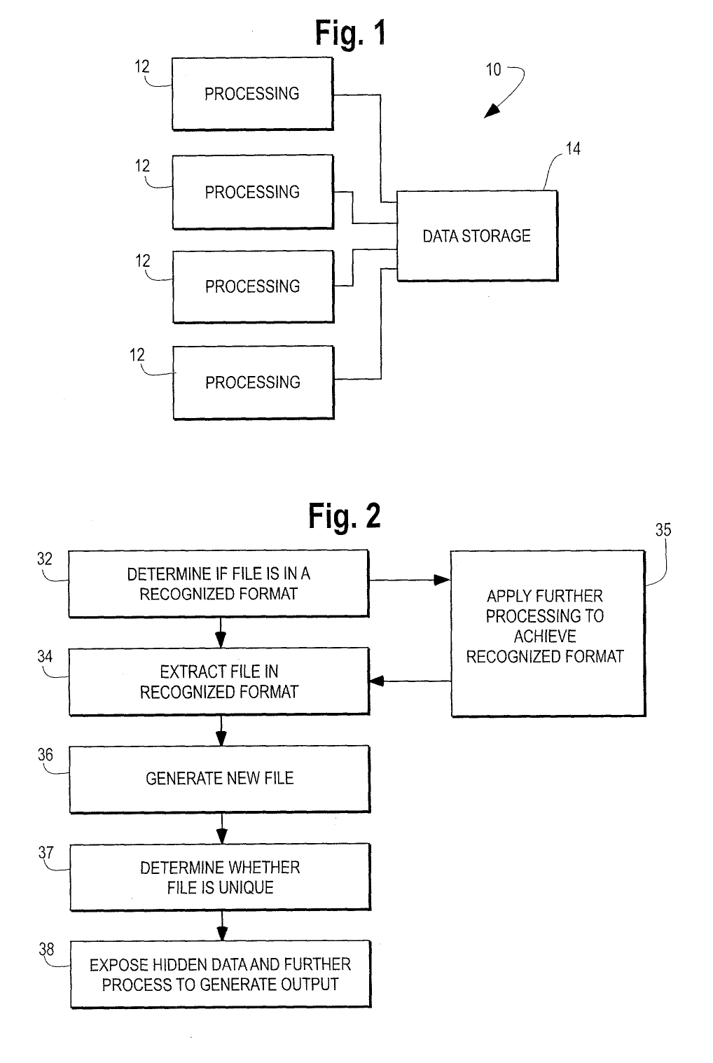

FIG. 1 illustrates a first preferred exemplary embodiment of the present invention that is shown generally at 10. In accordance with the first preferred exemplary embodiment, the illustrated system is capable of automatically processing electronic data files found in a variety of different file formats in order to generate comprehensive output comprising all of the data contained within the files including hidden data. Additionally, in accordance with the preferred exemplary embodiment of the present invention, the system is preferably configured to automatically generate a database of information pertaining to the files that have been processed by the system along with an identification of the specific processing that has been performed on each of the files. The database of this information is useful not only in determining the overall progress that has been made in the processing of the files but also to provide the ability to rapidly determine chain of custody and processing information. This database is also useful in overcoming any challenges to use of the data that are generated by the systems and methods of the present invention.

In accordance with a first preferred exemplary embodiment of the present invention, systems and methods are disclosed which are capable of simultaneously processing electronic data files on a plurality of computers 12 that are programmed to generate comprehensive output in either a common format such as, for example, tiff files or through output generated from native applications. In accordance with the first preferred exemplary embodiment of the present invention, a directory structure that maybe comprised of a plurality of user data files including, for example, document files which may be found in a variety of different file formats and/or electronic mail files for a plurality of users are processed to generate a comprehensive output comprising all of the information contained within the files including hidden information.

In accordance with the first preferred exemplary embodiment of the present invention, the directory structure of all the files to be processed is initially provided for processing by the processing computers 12. The underlying data may be contained within a variety of one or more different data storage devices that are physically delivered for connection to the processing computers 12 such as, for example, via CD-ROMs and/or hard disk drives or tape and the like. Regardless of the type of the data storage device, the information is preferably connected to storage that may be accessed by the processing computers 12 through a network connection. Alternatively, the data may be provided to the processing computers 12 directly through a network connection without physically transferring storage media such as, for example, the Internet or alternatively, through a local network connection when on location work is performed.

In the preferred exemplary embodiment of the present invention, a plurality of processing computers 12 which are preferably individual personal computers are connected to the data storage device 14 containing the file structure to be processed by the systems and methods of present invention. The data storage device 14 may be embodied as a server that has the directory structure stored therein for access by the processing machines 12. In the preferred exemplary embodiment, there are up to 60 drones or processing machines 12 which are tasked with processing of the individual files located within the directory structure.

In the preferred exemplary embodiment, one of the personal computers 12 connected to the network to which the storage device 14 containing the data to be processed is also connected is utilized for generating and maintaining a database of information pertaining to the files that are being processed by the systems and the processing that has been performed upon each of the individual files. A plurality of computers are utilized by the system in order to process the overall directory structure in parallel to thereby more efficiently process the underlying information. This is accomplished by assigning portions of the overall directory structure that is to be processed to each of the processing machines or personal computers 12. In the preferred exemplary embodiment, assignment of tasks is accomplished by evaluating the quantity of underlying data and providing approximately an equivalent load on each of the processing machines.

As various steps in the processing of the underlying data are performed, each of the individual machines transfers information to the processing machine that is tasked with the responsibility of generating the database information. The designated machine updates the database containing the file processing information in order to provide a comprehensive listing of the processing that has been performed on each of individual files within the directory structure. In the preferred exemplary embodiment, the database is a SQL database, however, those skilled in the art will appreciate that a variety of database formats may be utilized. All that is necessary is that the database be capable of receiving information in order to automatically update the information concerning the processing of the files.

FIG. 2 is a flow diagram which illustrates generally how each of the individual processing machines 12 handles the processing of the individual files which have been assigned for processing by the machine. As shown in FIG. 2, in a first step 32, the system automatically detects or determines whether a particular file or mail message attachment is in a recognized file format. If the file is in a recognized format, the processing machine then launches an instance of the native application if the program has not already been launched in order to open the file which is currently being processed in its original native file format. This extraction step occurs in step 34. In step 35 it is determined whether additional processing is necessary in order to identify the particular file format.

For example, this step is necessary when the file is a zipped or otherwise compressed file. When this occurs, the file must be processed or otherwise decompressed in order to identify the format of the underlying data. The step of determining whether additional processing is required prior to identifying the file format for the underlying data may be repeated again as necessary if it is determined that a decompressed file is actually still in a compressed file format. At each stage in the processing of the file information, the processing machine 12 responsible for processing of the file transmits information to the processing machine responsible for maintaining the database information in order to ensure that the database accurately reflects both the current status of the overall processing progress as well as in order to maintain an accurate listing of all the processing that has taken place with respect to each of the data files for chain of custody purposes.

In the preferred exemplary embodiment, for example, an e-mail message containing a zipped file is unzipped in order to determine the underlying file structure. If necessary, this step is performed repeatedly until a recognized file format is accessed. At each step along the way, the database is updated to include information pertaining to operations that have been performed on the file. Once a recognized file format has been identified, the file is then opened in its native format. Thereafter, after some additional subsequent processing which will be described in more detail below, in one embodiment the file is printed to a common format such as, for example, the tiff image format. Alternatively, a new processed file is created that is maintained in the original native application file format. Regardless of the subsequent processing to be performed, once the underlying file format has been identified, a new version of the file is generated in step 36 which is preferably the format of the original file.

In accordance with the preferred exemplary embodiment, as shown in step 37 of FIG. 2, in order to eliminate the generation of redundant information for subsequent review, the system is configured to automatically ensure the file being processed by the processing machine is unique and that no other identical files are processed by the system. This is accomplished through calculating the MD5 or other hash code for the each of the files prior to subsequent processing. Preferably, this occurs immediately after the file format for the original native application of the underlying is identified. This information is preferably transferred to and maintained within the database containing all the processing information for the files are processed by the system. Therefore, each of the processing machines has convenient access to this information in order to ensure that the machine is not performing redundant tasks by essentially repeating the processing of the underlying file multiple times.

In the processing of information from large organizations, it is not uncommon for processing systems to encounter significant volumes of duplicate files. This occurs in many instances because files have been initially transmitted, forwarded, or otherwise retransmitted as attachments to electronic mail messages that are transmitted to numerous individuals within the organization. Thus it is important and preferred that this step be performed in order to eliminate the review of redundant information.

In step 38 of FIG. 2, once the underlying file has been identified, the machine responsible for processing this file performs additional processing to thereby ensure that all of the data contained within the file may be readily presented to an individual viewing the output. This preferably occurs regardless of whether the ultimate file output is in a common file format such as, for example, the tiff image file format or if the output is a further file in the format of the original native application.

In accordance with the preferred exemplary embodiment, when the file is opened in its native format, the file is manipulated to display any hidden text that may be available. For example, this may include such things as, for example, track changes information in Microsoft Word and other similar data. This processing information is similarly updated in the database to ensure that all of the relevant file processing information may be readily accessed.

The additional processing that may be performed includes the reconstruction of redlining information and the ability to render PowerPoint speaker notes into readily viewable text. The system is also preferably configured to automatically handle files that have been generated with A4 paper size. Preferably, this additional processing is performed automatically by the systems. The system processing machines 12 operate under the control of a computer program which has been created to automatically sense and manipulate these file characteristics. Those skilled in the art will recognize that these are merely examples of the processing that may be performed on the underlying data. It should be readily recognized that other processing may also be performed and monitored by transferring information to the database.

Regardless of whether the preferred file output is a single common format such as, for example, the tiff image file format or whether the output is a plurality of files each of which are in the original file format of the underlying data, output product is generated for the customer. This may be a CD-ROM or other removable media. Each user of the system is able to provide specifications for the layout of the output data. For example, if a client desires to load the images into a document management system, this will require text-based supporting batch load files which enumerate the image files and associate them with data concerning the documents from which they were originally generated. This is similarly true of output that is selected to be in the native format of the original files.

In accordance with the preferred exemplary embodiment of the present invention, each new client format is encapsulated within a dynamic linked library file (.dll) that is provided with a simple and convenient interface. Thus, in order to add a new client format to the system, the computer programmer assigned with this task need only write code that is tailored to the specifically selected format of the particular client. This is due to the fact the general housekeeping, set up and error-checking work is performed by the main program. Once the dynamic linked library file is copied to the directory where the code is stored, it is automatically picked up by the main program and added to the list of available output formats.

One primary advantage of this process over manual or other automated methods is that all the required load files (the text files describing the image data and source files) are created at the same time that the images are being staged for burning. This ensures that the load files and the output image that has been created are synchronized. Other prior methods performed the steps as separate operations which introduced the possibility that the text files could get out of sync with the data that they were describing.

An additional advantage of this preferred alternate exemplary embodiment of the present invention is the consolidation of “common” handling operations into the main code module, such as, for example, the gathering of initial information and the creation of directory folders, etc. As a result, each new output format does not require that this code be newly written each time. Furthermore, the functions required for each particular output format are preferably incorporated into a module interface that is common across all of the output formats that are available. Accordingly, any number of new formats can be added to the primary program at any time simply by dropping a .dll containing code for that format into the .dll directory for the main application. The main application picks up the format and makes available without having to change and events on code. An added advantage is that any computer program developer, not just the one who created the main program routines can readily develop a new format.

An alternative approach to the use of a database for storing the information described herein is to use data structures that allow for the storage of the same information without using database software, tables, or other items that are associated with database structures. The most simple among these is the use of structured data along the lines of fixed length text files, comma delimited text files or other mechanisms that allow easy correlation and storage of the proper information. This approach would be implemented along the same lines as using a database, but the operations for finding, inserting, deleting and other operations needed to handle the necessary functionality would be added to the software instruction set. In this alternate approach, although the need for a database per se has been eliminated, the acquisition, storage and use of the file processing data is similar and provides similar benefits to embodiment which utilize database structures.

Another alternative approach is the use of store and forward systems or workflow software to manage the same functionality. Store and forward systems are fundamental to email systems and can be used to identify a sequence of operations and track data along with these operations. If a commercial email system is used for this purpose, it would require the use of special instructions in order to operate properly. These intructions would provide the system with the identity of each process, provide an address for each process and include any special logic for determining the next operation necessary in the system under certain conditions.

Workflow software uses the concept of queuing to accomplish similar functionality. In this alternative approach, each function of the system would be provided an identity to the system along with any logic necessary for handling certain conditions in the system.

In an alternate system configuration, an alternative approach to the system requiring an operator to designate specific processors to operate, would be the use of distributed computing concepts such as DCOM or CORBA. These protocols allow a computer system to automatically distribute the work done on a computer system by the use of software “beacons” that indicate that a specific part of the system is available to execute a task or is busy.

An alternative approach to the use of a networked system is the use of a single computer system. This system could be a personal computer, UNIX workstation, midrange or mainframe computer. In this approach, rather than data being stored and processed on separate computers, all of the functionality of the system would be operational on a single machine. In this approach, operations could be multithreaded as they are on a networked system, or included in a single software program. This would require only simple modification from the existing system to be accomplished.

An alternative approach to using the file system of the computer system to store individual files for processing is the use of a database system or other application that embeds these files and tracks their use. In one variation of this approach, one could use the Binary Large Object field type of a database system to hold the file and deliver it to the system when needed. This would require the use of software code to deliver the file to the system when it's use is required. In effect, this approach would operate the same way as described in the main application except the database program would serve files rather than the file system.

As described above, the systems and methods of the present invention provide the ability to automatically acquire data concerning the processing that has taken place with respect to files that are handled by the system. Additional information which may be acquired and maintained in the database includes keyword searching file information. This information is useful, for example, when a client requests identification of all documents having one or more terms contained within the text of the document. The presence or absence of certain terms may thus also be included in the database of information.

In the preferred exemplary embodiment, additional information that is contained within the database includes file audit information which identifies what transactions have taken place with respect to each of the source files. Additionally, the database preferably contains information sufficient to provide a correlation between each of the original files and the output images or files. As a result, with this information, users are easily able to identify source files associated with output images as well as identify output image is that have been generated from original source files. As noted above, the audit information preferably includes a cyclic redundancy check or CRC information. The MD5 value is one such calculation that may be used. In addition to eliminating duplicate files, this information may be utilized in order to eliminate unnecessary data such gas, for example, executables or other files associated with programs utilized by a user. For example, the Microsoft Word program has a large numbers of files associated with the program which the program utilizes in the generation of Microsoft Word file documents. If the system has contained within the database information identifying a unique code or value associated with these files, then when the calculation is performed on a particular file and a match is determined, the file can be subsequently disregarded.

Additionally, user information may be included in the database. This may be helpful in providing a correlation between user files when a particular user has numerous designations. This may occur, for example, when a person is married and has received multiple user names for accessing the system. In such situations, multiple electronic mail accounts will likely exist. The information in the database can be used to ensure the appropriate correlation is maintained.

Bates or similar numbering system information may also be acquired and maintained by the system. This may be helpful in providing a unique identifier for each output image that is created by the system. Correlation between underlying data and the output images or files can readily be achieved.

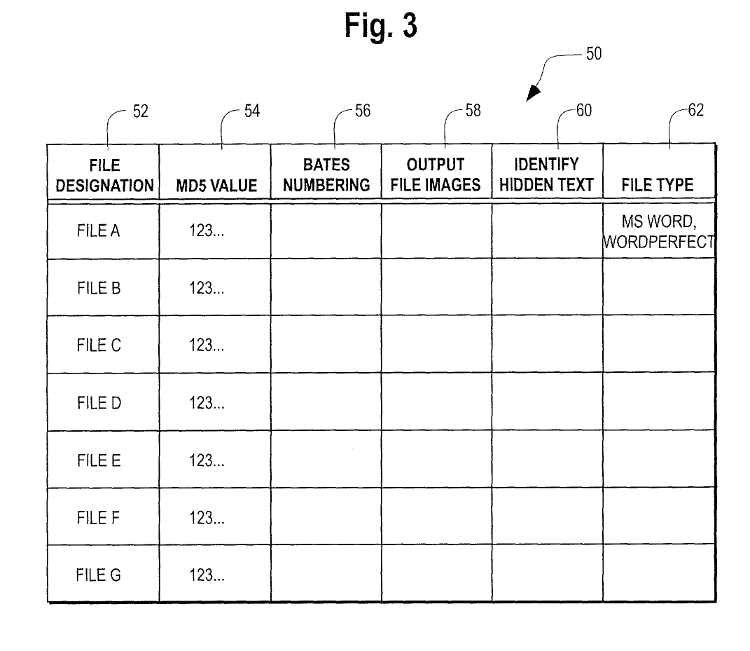

FIG. 3 is an exemplary illustration of the data that is acquired and maintained in accordance with the systems and methods of the present invention. Those skilled in the art will appreciate that alternate database configurations may also be readily utilized. As shown in FIG. 3, a database 50 contains file processing information in a variety of information containing fields. The first column 52 provides file designation information for each of a plurality of files.

Column 54 contains the MD5 calculation described above which is utilized in ensuring that duplicate processing on multiple files is not performed. Bates numbering information is set forth in column 56 and a correlation between the original file designation and the output file images is provided in column 58. Column 60 provides an identification of hidden text and column 62 identifies the file types such as, for example, Microsoft Word, or WordPerfect etc. It should be readily apparent to those skilled in the art that other file processing information can be readily incorporated into the database described herein. As noted above, alternate information storage techniques may be utilized including the use of XML and XMLS files in order to eliminate the need for a database.

We claim:

1. A method for processing files located within a directory structure in order to generate output data comprising the steps of:
assigning the processing of portions of an overall directory structure respectively to each of a plurality of individual processing machines;
processing files from an assigned portion of the overall directory structure by each of the processing machines in order to generate output data; and
transferring information identifying processing steps that have been performed by each processing machine on each file to a database containing file processing information.

2. The method of claim 1, further comprising a step of storing the overall directory structure in a CD-ROM that is accessible through a drive that is connected through a computer network to the processing machines.

3. The method of claim 1, further comprising a step of storing the overall directory structure in a hard disk drive that is accessible through a computer network to the processing machines.

4. The method of claim 1, further comprising a step of storing the overall directory structure in a tape drive that is accessible through a computer network to the processing machines.

5. The method of claim 1, further comprising a step identifying that the processing of a file has not been previously performed by the system.

6. The method of claim 5 wherein the step of identifying that the processing of a file has not been previously performed by the system is comprised of a step of calculating an MD5 value.

7. The method of claim 1, further comprising an additional step of generating a plurality of output files corresponding to the files contained within the overall directory structure, wherein the output files are all in a common file format.

8. The method of claim 1, further comprising an additional step of generating a plurality of output files corresponding to the files contained within the overall directory structure, wherein the output files are all in the native file format to the corresponding underlying files from the original data.

9. A system for processing files located within a directory structure in order to generate output data comprising:
a means for assigning the processing of portions of an overall directory structure respectively to each of a plurality of individual processing machines;
a plurality of individual processing machines comprising means for processing files from an assigned portion of the overall directory structure by each of the processing machines in order to generate output data; and
a means for transferring information identifying processing steps that have been performed by each processing machine on each file to a database containing file processing information.

10. The system of claim 9, further comprising a means for storing the overall directory structure in a CD-ROM that is accessible through a drive that is connected through a computer network to the processing machines.

11. The system of claim 9, further comprising a means for storing the overall directory structure in a hard disk drive that is accessible through a computer network to the processing machines.

12. The system of claim 9, further comprising a means for storing the overall directory structure in a tape drive that is accessible through a computer network to the processing machines.

13. The system of claim 9, further comprising a means for identifying that the processing of a file has not been previously performed by the system.

14. The system of claim 13 wherein the means for identifying that the processing of a file has not been previously performed by the system is comprised of a means for calculating an MD5 or other hash value.

15. The system of claim 9, further comprising a means for generating a plurality of output files corresponding to the files contained within the overall directory structure, wherein the output files are all in a common file format.

16. The system of claim 9, further comprising a means for generating a plurality of output files corresponding to the files contained within the overall directory structure, wherein the output files are all in the native file format to the corresponding underlying files from the original data.
